(19) United States
(12) Patent Application Publication
(10) Pub. No.: US 2026/0221021 A1
(43) Pub. Date: Jul. 30, 2026

(54) NEGATIVE ATTENTION PATTERN NOTIFICATION

(71) Applicant: INTERNATIONAL BUSINESS MACHINES CORPORATION, ARMONK, NY (US)

(72) Inventors: Jeremy R. Fox, Georgetown, TX (US); Zachary Augustus Silverstein, Georgetown, TX (US); Amber Morgan, Dallas, TX (US); Logan Bailey, Atlanta, GA (US)

(21) Appl. No.: 19/037,910

(22) Filed: Jan. 27, 2025

(51) Int. Cl. G08B 21/24

(52) U.S. Cl. CPC G08B 21/24

(57) ABSTRACT

A method, computer program product, and computer system for monitoring content consumption and alerting a user to a negative attention pattern. An application interaction by the user on one or more electronic devices is detected and a monitoring time period is initiated. Content consumption by the user on the one or more electronic devices over the monitoring time period is monitored and the monitored content consumption by the user over the monitoring time period is evaluated for a negative attention pattern. An alert is generated when the negative attention pattern is determined to be present.

### BACKGROUND

The present invention relates to user consumption of, and attention to, electronic content such as social media and news sites.

### SUMMARY

Embodiments of the present invention provide a method, a computer program product, and a computer system, for monitoring content consumption and alerting a user to a negative attention pattern. The method includes detecting an application interaction by the user on one or more electronic devices and initiating a monitoring time period in response to detecting the application interaction by the user on the one or more electronic devices. The method further includes monitoring content consumption by the user on the one or more electronic devices over the monitoring time period, wherein monitoring content consumption by the user includes monitoring content being consumed by the user, monitoring one or more applications used by the user, and/or capturing application interaction data of the user with the one or more applications being used by the user. The method further includes evaluating the monitored content consumption by the user over the monitoring time period for a negative attention pattern and generating an alert when the negative attention pattern is determined to be present.

### BRIEF DESCRIPTION OF THE DRAWINGS

FIG. 1 depicts a computing environment which contains an example of an environment for the execution of at least some of the computer code involved in performing the inventive methods, in accordance with embodiments of the present invention.

FIG. 2 is a block diagram of modules included in code included in the system of FIG. 1, in accordance with embodiments of the present invention.

FIG. 3 is a flow chart of an embodiment of a method for monitoring content consumption and alerting a user to a negative attention pattern, in accordance with embodiments of the present invention.

FIG. 4 is a flow chart of a further embodiment of a method for monitoring content consumption and alerting a user to a negative attention pattern and depicts an exemplary flow of operations in accordance with embodiments of the present invention.

### DETAILED DESCRIPTION

### OVERVIEW

Users of all ages are spending increased amounts of time watching and/or using electronic devices such as computers, smart phones, tablets, phablets, monitors, televisions, video walls, medical monitors, computer monitors, virtual reality displays, and the like. Many of these devices can push content to the user, i.e., provide content for consumption by the user even without the user necessarily seeking out the content. Likewise, various applications on such electronic devices are also capable of pushing content and/or providing a continuous stream of content for consumption. Social media applications and news sites are examples of applications with such features.

Users may find themselves consuming content without purpose or intent, an activity that may be referred to as “doomscrolling.” For example, after viewing content users may decide to stop viewing the content but may then find themselves viewing content again, either the same content or similar content. As a further example, users may find themselves viewing the same content or similar content on different devices, different applications, and combinations thereof.

As an example, a user may close one social media application only to find that they have opened the same social media application again within a few minutes. Alternatively, a user may close one social media application only to find that they have opened a different social media application within a few minutes.

As another example, a user may close one social media application on a first device (for example, a computer) only to find that they have opened the same social media application on a second device (for example, a mobile device). Alternatively, a user may close one social media application on a first device only to find that they have opened a different social media application on a second device.

Still further, examples may include closing one type of content only to open a different type of content. For example, a user may stop browsing social media videos only to then view social media photos or other posts.

Still further, a user may engage in mindless scrolling through social media posts, falling asleep while content is displayed, and other actions that indicate the user is consuming content out of boredom, distraction, and the like rather than with a purpose or intent.

These situations may be referred to as negative attention or negative attention pattern. The user is consuming content without attention/focus. Such conditions are often a form of distraction, disinterest, and the like.

Negative attention patterns can be detected and addressed using approaches as described herein. Embodiments of the present invention monitor content consumption by a user, determine if the user demonstrates a negative attention pattern, and alert the user.

Embodiments of the invention may evaluate monitored content consumption, for example, monitoring the content itself and/or the user’s interaction with the content, interaction with an application, interaction with the electronic device, and the like. Embodiments may be applicable to content on a single device, on two devices (bimodal consumption), or on more devices. The evaluation may be temporally limited, i.e., may evaluate content/interactions within a recency period. Past content consumption history may also be used, for example, as part of evaluating a user’s typical usage patterns during intentional/purposeful use of the electronic device as opposed to unintentional/purposeless use of the electronic device.

In embodiments, the user’s intentionality/purposefulness may be determined. For example, embodiments may determine intentionality/purposefulness based on specific micro-behaviors in how the user interacts with the application, consumes content, and the like. Factors include timing, for example, how long the user takes on specific content/media. As an example, the user may take a longer time viewing specific content/media that is consumed intentionally/purposefully while taking a much shorter time to view or scroll past other content/media. Further, there may be an expected amount of time for consuming content/media depending on the type of content/media, the type of application, the type of electronic device, and other factors. A negative attention pattern including a lack of intentionality/purposefulness may be found when a user’s consumption deviates from expectations and/or from the user’s typical patterns.

In embodiments, a user is made aware of a negative attention pattern through an alert. Further, in embodiments, additional action may be taken to help the user end the negative attention pattern and/or avoid future negative attention patterns. The alert may bring the user’s behavior patterns to the forefront of the user’s mind, resulting in increased intentionality/purposefulness. The alert may also indicate the user has been consuming content for too long, should take a break, etc. Still further, in embodiments, the alert may include requiring the user to take an action to continue viewing content, automatically disabling content, automatically disabling an application, automatically disabling the electronic device and the like.

### COMPUTING ENVIRONMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

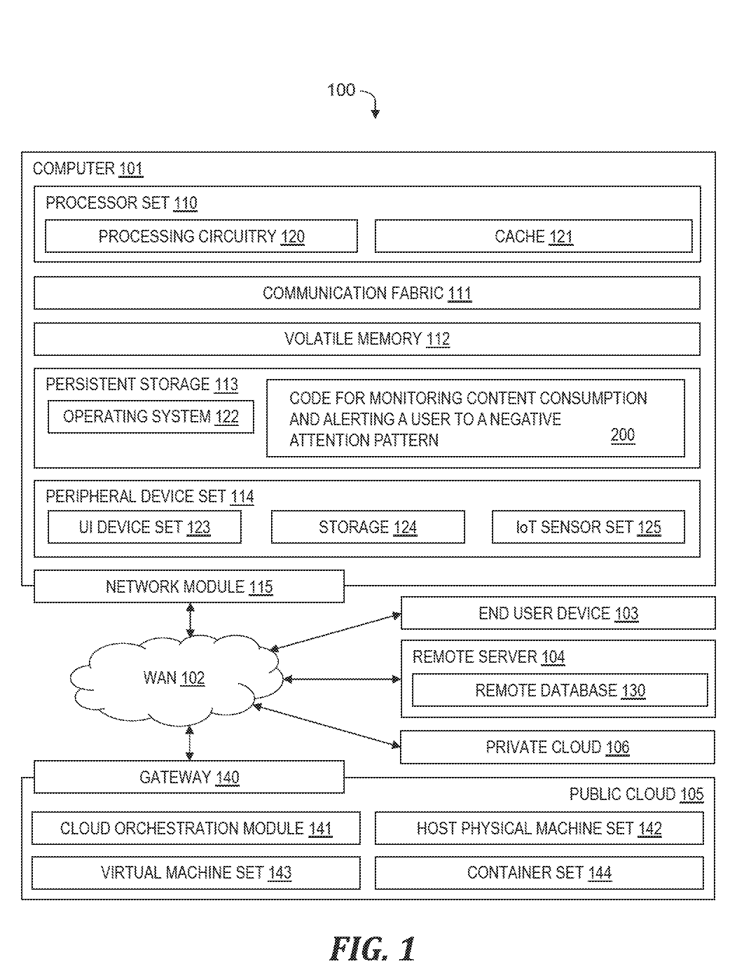

FIG. 1 depicts a computing environment which contains an example of an environment for the execution of at least some of the computer code involved in performing the inventive methods, in accordance with embodiments of the present invention. Computing environment 100 contains an example of an environment for the execution of at least some of the computer code involved in performing the inventive methods, such as code 200 for monitoring content consumption and alerting a user to a negative attention pattern. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### PROCESS AND SYSTEM FOR MONITORING CONTENT CONSUMPTION AND ALERTING A USER REGARDING A NEGATIVE ATTENTION PATTERN

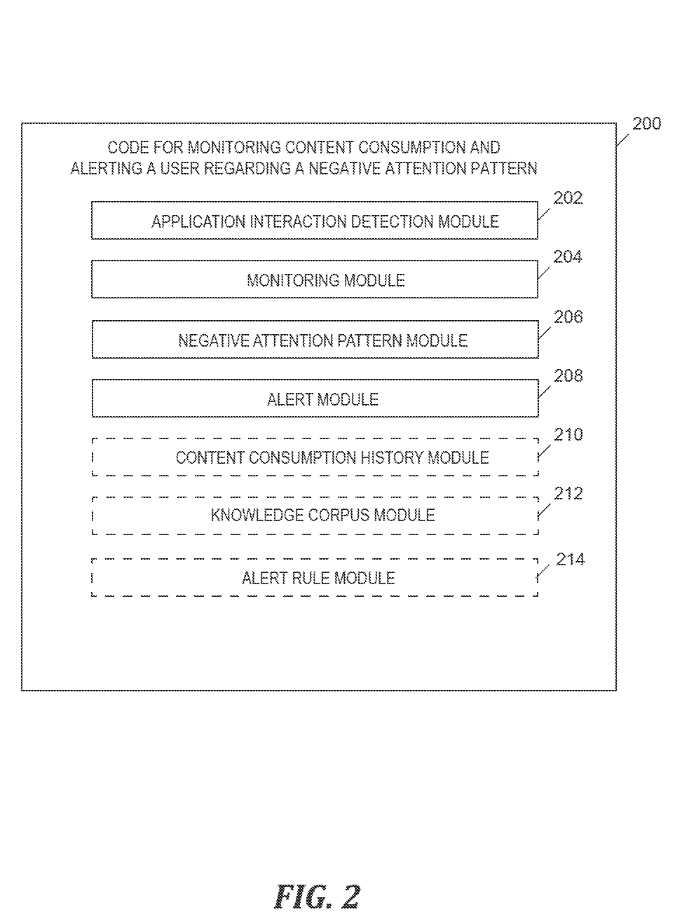

FIG. 2 is a block diagram of modules included in code included in the system of FIG. 1, in accordance with embodiments of the present invention. Code 200 includes application interaction detection module 202, monitoring module 204, negative attention pattern module 206, and alert module 208 in embodiments. The number of modules can vary and some modules may be combined with other modules or separated into two or more modules. Additional modules may also be included. For example, in embodiments, content consumption history module 210, knowledge corpus module 212, and/or alert rule module 214 may also be included in code 200.

Application interaction detection module 202 detects a user’s interaction with an electronic device or devices, for example, an interaction with an application on the electronic device and/or content on the electronic device and/or application. The application interaction detection module 202 may be configured to detect specific types of interactions, interactions with specific applications (for example, social media applications, news sites, and the like), interactions with specific content (for example, social media content, news stories, and the like), or otherwise detect specific uses of the electronic device and/or application. The electronic device may be one or more electronic devices. For example, the user may have a plurality of electronic devices such as a mobile device, a laptop, a desktop computer, a tablet, a phablet, a television, a virtual reality system, and the like.

Monitoring module 204 is configured to monitor the user’s interactions with the electronic device. In embodiments, the monitoring module may initiate a monitoring time period in response to detecting the application interaction by the user on the electronic device. The monitoring time period may include a counter of recency, for example, evaluating and weighing the recency of the user’s interactions and content consumed. The monitoring module may monitor the user’s interactions with the electronic device, for example, content consumption by the user on the electronic device. Monitoring content consumption by the user may include, for example, monitoring the content itself, monitoring applications being used, capturing application interaction data of the user with the electronic device, and the like. Respective timing of content consumption may be included in the monitoring, for example, timing of the content consumed, timing of the user’s interactions, and the like. Monitoring may be performed across multiple electronic devices in embodiments.

Negative attention pattern module 206 is configured to evaluate the monitored content consumption over the monitoring time period. The monitored content consumption is evaluated for a negative attention pattern. In embodiments, evaluating is performed with reference to the counter of recency, for example, evaluating and weighing the recency of the user’s interactions and content consumed.

The negative attention pattern may be information regarding the user’s actions and/or the consumed content that demonstrates that the user is acting without intentionality/purposefulness as discussed above. For example, an intentionality score may be determined. As discussed above, embodiments may determine intentionality/purposefulness based on specific micro-behaviors in how the user interacts with the application, consumes content, and the like. Factors include timing, for example, how long the user takes on specific content/media. For example, the user’s interactions with the application may indicate distraction, disinterest, sleepiness, mindlessness, or other states of the user. Likewise, the consumed content may indicate similar states of the user. As an example, the user may take a longer time viewing specific content/media that is consumed intentionally/purposefully while taking a much shorter time to view or scroll past other content/media. Conversely, a rate of content consumption that is too slow may indicate the user is not really paying attention, is distracted, is falling asleep, and the like. Information such as the user’s interaction (clicking, tapping, etc.) with the content, application, and/or electronic device may be included as part of the evaluation. As further examples, there may be an expected amount of time for consuming content/media depending on the type of content/media, the type of application, the type of electronic device, and other factors. A negative attention pattern including a lack of intentionality/purposefulness may be found when a user’s consumption deviates from expectations and/or from the user’s typical patterns.

In embodiments, the negative attention pattern may include that the user consumed repetitive content, the user non-purposefully consumed content, and/or the user non-purposefully consumed repetitive content.

As discussed above, a plurality of electronic devices may be involved in some embodiments. For example, a user may have multiple devices on which application interactions may be detected and on which monitoring may occur. In embodiments, the monitoring and evaluating steps may take place for interactions and/or content on two or more electronic devices. For example, evaluating the content consumption for the negative attention pattern may include determining that the user consumed content on a first electronic device and consumed content on the second electronic device. A negative attention pattern may be determined if repetitive content is consumed on the two different devices, for example, within a specified time frame. A negative attention pattern may be determined if the user non-purposefully consumes content especially across the two different devices. Still further, a negative pattern may be determined if the user non-purposefully consumes repetitive content across the two different devices.

In a further embodiment, a negative attention pattern, or at least the potential for a negative attention pattern, may be determined based on the use of different first and second devices. Alternatively, additional weight may be given to the fact that different devices are used. For example, many applications have a different felt experience to the user when viewed on different platforms or devices (for example, mobile application v. full website version) and the user may not be aware of the different felt experience. Embodiments may account for this by weighting consumption on multiple devices more heavily. Further, the user may benefit from being more aware of the fact that they are using a second device.

It will be understood that additional devices may also be included, for example, a negative attention pattern may be determined based on user interactions and content consumption across three or more devices.

Alert module 208 is configured for generating an alert regarding the negative attention pattern. The alert may be provided to the user, for example, on the electronic device. As examples, the alert may be a notification, message, text, or other action provided or visible to the user. In embodiments, the alert may include a recommendation to take a break, a recommendation to go outside, a recommendation to go to bed, a recommendation for a different application, activity, or content, for example, one that requires thoughtful or purposeful interaction, and the like. In embodiments, alerts may include actions such as closing, disabling, or otherwise interacting with the content and/or application. For example, in embodiments, the alert may include requiring the user to take an action to continue viewing content, to continue using the application, to continue using the electronic device, and the like. As further examples, the alert may include automatically disabling content, automatically disabling an application, automatically disabling the electronic device, and the like. Alerts may be provided in real time, at set intervals, as summary reports, and the like.

As discussed above, in embodiments, code 200 may include additional modules such as content consumption history module 210, knowledge corpus module 212, and/or alert rule module 214.

Content consumption history module 210 may be configured to provide and/or store a consumption history for the user. For example, consumption history regarding the application and/or specific content may be stored. In embodiments, the content consumption history for the user includes information regarding the electronic devices, applications on the electronic devices, and/or specific content consumed.

Knowledge corpus module 212 may be configured to provide a knowledge corpus based on the content consumption history. For example, in embodiments the knowledge corpus may include a timestamp, a length of time, an identification of the electronic devices, an action classification, an identification of a type of content, an identification of a specific item of content, an application, an item of interaction data, and combinations thereof.

Alert rule module 214 may be configured to provide a rule for alerting the user. In embodiments the rule may weigh criteria including time spent on a respective electronic device, time spent on collective electronic devices, single sessions logged, multiple sessions logged, time spent on respective applications, times content has been viewed, number of repetitive content viewed, and combinations thereof.

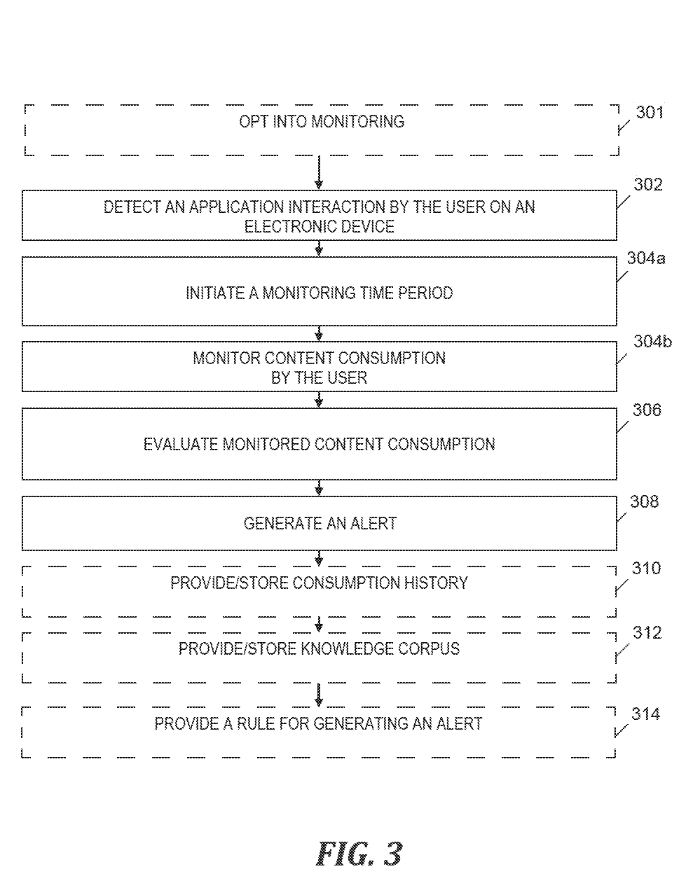

In addition to the foregoing, functionality of the various modules included in code 200 is discussed in additional detail with respect to FIG. 3, below.

FIG. 3 is a flow chart of an embodiment of a method for monitoring content consumption and alerting a user to a negative attention pattern, in accordance with embodiments of the present invention. The process of FIG. 3 begins at a start node 300.

In step 302, an application interaction by the user on one or more electronic devices is detected. For example, the user may interact with an application and/or begin consuming content.

In step 304a, a monitoring time period is initiated. In embodiments, the monitoring time period may include a counter of recency indicating when a user began interacting with the application, consuming content, and the like. In step 304b, content consumption by the user is monitored, for example, over the monitoring time period. Monitoring is discussed in detail above.

In step 306, the monitored content consumption is evaluated. For example, the monitored content consumption is evaluated for a negative attention pattern. Evaluating is discussed in detail above, as is the negative attention pattern. In embodiments, evaluating may include determining an intentionality score and/or determining re-consumption of content or consumption of repetitive content, for example, within a time period or with respect to a counter of recency.

In step 308, an alert is generated. For example, an alert may be generated when a negative attention pattern is detected. The alert may notify the user of the negative attention pattern and/or take other action as discussed above.

As depicted in FIG. 3, in embodiments the method includes optional step 301 in which a user opts into monitoring. Based on the user opting into monitoring, one or more electronic devices of the user may be configured to connect to or communicate with a server or computing device including code 200, to download code 200, to download modules of code 200, and the like.

Embodiments may also include optional steps 310, 312, and/or 314. In optional step 310, consumption history is provided and/or stored. As discussed above, consumption history regarding the application and/or specific content may be stored. In embodiments, the content consumption history for the user includes information regarding the electronic devices, applications on the electronic devices, and/or specific content consumed. In optional step 312, a knowledge corpus based on the content consumption history is provided and/or stored. As discussed above, in embodiments the knowledge corpus may include a timestamp, a length of time, an identification of the electronic devices, an action classification, an identification of a type of content, an identification of a specific item of content, an application, an item of interaction data, and combinations thereof. In optional step 314, a rule for alerting the user may be provided. As discussed above, in embodiments the rule may weigh criteria including time spent on a respective electronic device, time spent on collective electronic devices, single sessions logged, multiple sessions logged, time spent on respective applications, times content has been viewed, number of repetitive content viewed, and combinations thereof. It will be understood that additional method steps may also be included.

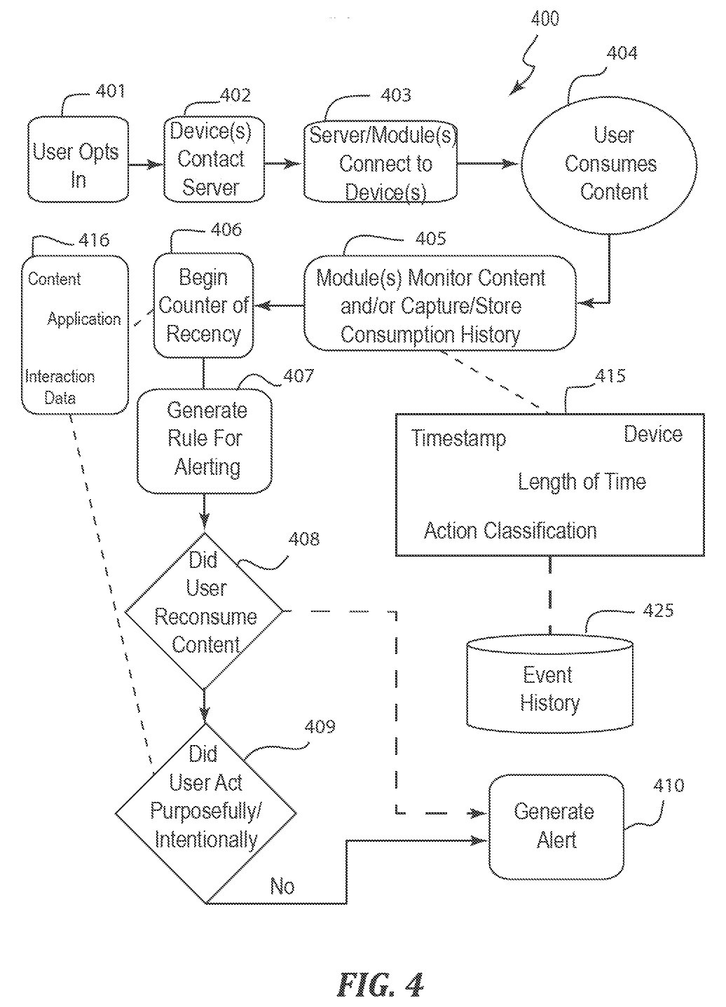

FIG. 4 is a flow chart of a further embodiment of a method for monitoring content consumption and alerting a user to a negative attention pattern and depicts an exemplary flow of operations 400, in accordance with embodiments of the present invention.

In step 401, a user may opt into a monitoring service. By opting in, the user may provide permission for monitoring to take place. The user may opt in for a single electronic device, a plurality of electronic devices, all of the user’s electronic devices, or a subset of the user’s electronic devices, as desired.

In step 402, electronic device(s) of the user may contact or communicate with a server or centralized computing device. For example, the device(s) for which the user has opted in may contact or communicate with the server or centralized computing device. It will be understood that this contact or communication may proceed in either direction, and the electronic device(s) may contact or communication with the server or centralized computing device and/or the server or centralized computing device may contact or communication with the electronic device(s).

In step 403, the server or centralized computing device may connect to the electronic device(s). In embodiments, code 200 and/or the modules thereof may be present at the server or centralized computing device, and operations such as those discussed above may take place at/by the server or centralized computing device. In other embodiments, code 200 and/or the modules thereof may be transmitted to the electronic device(s), for example, downloaded and stored on the electronic device, and operations such as those discussed above may take place at/by the electronic device.

Proceeding to step 404, a user may consume content as discussed above. For example, a user may interact with an application on the electronic device(s), may view content on the electronic device, and the like.

In step 405, code 200 and/or the module(s) thereof may monitor content as discussed above. Code 200 and/or the module(s) thereof may also capture and store consumption history as discussed above. As shown in box 415, the consumption history may include information regarding the electronic device, application interaction, content, and the like. For example, consumption history may include information such as a device, a timestamp, a length of time, an action classification, and the like. As shown in box 425, an event history may be stored. Referring to the embodiments discussed above, a knowledge corpus may be created for the user, the electronic device(s), and/or applications.

In step 406, a counter of recency may begin based on the user’s interactions. For example, the counter of recency may track time that passes while the user interacts with the electronic device(s), applications, or content. During that time, the user may be consuming content and the content being consumed, application interactions, and interaction data are monitored, captured, and/or stored as shown in box 416. Box 416 may also include additional information such as the information in one or more of boxes 415 and 425. In embodiments, the counter of recency may track time between application interactions, time between content consumption, time between consumption of similar content, time related to user actions regarding content, length of time spent consuming content, length of time using an application, length of time using a device, and the like.

In step 407, a rule for alerting the user is generated. As discussed above, a variety of factors may be used in generating the rule. In embodiments the rule may weigh criteria including time spent on a respective electronic device, time spent on collective electronic devices, single sessions logged, multiple sessions logged, time spent on respective applications, times content has been viewed, number of repetitive content viewed, and the like.

Step 408 represents a decision point at which it may be determined whether the user re-consumed content, or in other words, whether the user consumed repetitive content. As discussed above, re-consuming content or consuming repetitive content may include viewing similar content in a short time period, viewing similar content on different applications, viewing similar content on different electronic devices, viewing similar applications in a short time period, viewing similar applications on different electronic devices. In further embodiments, re-consuming content or consuming repetitive content may include determining that a user’s social media feed has restarted/reset, i.e., the user is viewing content they have already viewed.

Step 409 represents another decision point at which it may be determined whether the user acted purposefully/intentionally. For example, if the user re-consumed content or consumed repetitive content and did so without purpose or intent, the user may be determined to have a negative attention pattern. The purpose/intent of the user may be determined using the information discussed above, namely, information from boxes 415, 416, and/or 425. Thus, the user’s interaction data and other information may be evaluated to determine if the user acted with purpose/intent when consuming the content. As examples, determination of purpose/intent may be based on content consumed, timing of consumption, interaction with content/application(s)/device(s), and the like.

If the user re-consumed content or consumed repetitive content and acted without purpose/intent, a negative attention pattern may be determined and the method may proceed to step 410 in which an alert is generated and provided to the user, for example, on the electronic device. As discussed above, the alert may be provided to the user, for example, as a notification, message, text, or other action provided or visible to the user and/or as an action such as automatically closing, disabling, or otherwise interacting with the content, application, and/or electronic device(s).

In embodiments, the alert may include a recommendation to take a break, a recommendation to go outside, a recommendation to go to bed, a recommendation for a different application, activity, or content, for example, one that requires thoughtful or purposeful interaction, and the like.

As indicated by the dashed line between step 408 and step 410, in embodiments, the determination that the user re-consumed content or consumed repetitive content may be sufficient to meet the rule and thus to generate the alert and/or take action. As examples, a user, the code 200, and/or a module thereof may have a setting such that re-consuming content or consuming repetitive content may automatically meet the rule, that re-consuming content or consuming repetitive content within a time span meets the rule, that re-consuming content or consuming repetitive content on a second device within a time span meets the rule. Additionally or alternatively, in some cases re-consuming content or consuming repetitive content may itself make it clear that the user is acting without purpose/intent without further evaluation. It will be understood that these are merely examples and other settings could be used.

Relatedly, in embodiments, step 408 may be omitted and an alert may be generated based on a determination regarding whether the user is acting purposefully/intentionally regardless of whether content is re-consumed or repetitive content is consumed. For example, a user, the code 200, and/or a module thereof may have a setting such that determining that the user acted without purpose/intent when consuming the content may meet the rule. Additionally or alternatively, in some cases user interaction may itself make it clear that the user is acting without purpose/intent without requiring evaluation of the respective content begin consumed.

In embodiments, an additional step (not shown) may include updating the event history and/or the knowledge corpus regarding the generated alert, user behavior, application interactions, and the like.

In further embodiments, a user may be provided with any patterns regarding determined re-consumption, repetitive consumption, and/or purposeful/intentional action. For example, the user may be provided with information showing that negative attention is prevalent during a lunch break, during early afternoon following lunch, late at night, and the like.

### EXAMPLES

Examples showing specific implementations according to embodiments of the present invention are now provided.

### Example 1

In Example 1, a user is scrolling on a social media application or news site. The user repeatedly views the same or similar content, for example, similar posts or similar news stories. The user’s behavior is determined to be consistent with a negative attention pattern (“doomscrolling”) and an alert is generated.

### Example 2

In Example 2 a user is on a social media application or news site on the user’s mobile device. After viewing content for several minutes, the user decides to return to work, puts down the mobile device, and interacts with a desktop computer. However, within a few minutes, the user is on the same social media application or news site viewing similar content. The user’s behavior is determined to be a negative attention pattern and an alert is generated. In this example, the alert may include informing the user that the content has already been consumed on the mobile device.

### Example 3

Example 3 is similar to Example 2. A user is on a social media application or news site on the user’s mobile device. After viewing content for several minutes, the user decides to return to work, puts down the mobile device, and interacts with a desktop computer. The user later uses the same social media application or news site. Embodiments may have a rule for alerting the user in this situation even if the user is not viewing the same content and/or is not re-consuming content or consuming repetitive content, on the basis that the user may not purposefully/intentionally be using the same social media application or news site. For example, many applications have a different felt experience to the user when viewed on different platforms or devices (for example, mobile application v. full website version). Thus, it may be beneficial to alert the user to the fact that they have already visited the social media application or news site on a different device.

### Example 4

In Example 4 a user is on a social media platform for the first time in the day and is viewing new content. While the user is scrolling through available content, the user is not engaging with any content, for example, is not taking any action other than scrolling. Instead, the user appears to be mindlessly/passively scrolling and consuming content. A negative attention pattern is determined and an alert is generated.

### Example 5

In Example 5 a user is using a social media application and no alert is generated. However, the user’s application interactions, content consumption, and the like are monitored, captured, and stored (for example, as consumption history, event history, and/or in a knowledge corpus) for future use, comparison, and the like.

As shown in the Examples, embodiments of the present invention provide monitoring of content consumption for negative attention patterns and alert the user to such negative attention patterns.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for monitoring content consumption and alerting a user to a negative attention pattern, comprising:
detecting an application interaction by the user on one or more electronic devices;
initiating a monitoring time period in response to detecting the application interaction by the user on the one or more electronic devices;
monitoring content consumption by the user on the one or more electronic devices over the monitoring time period, wherein monitoring content consumption by the user includes monitoring content being consumed by the user, monitoring one or more applications used by the user, and/or capturing application interaction data of the user with the one or more applications being used by the user;
evaluating the monitored content consumption by the user over the monitoring time period for the negative attention pattern; and
generating an alert when the negative attention pattern is determined to be present.

2. The computer-implemented method of claim 1, further comprising:
providing a content consumption history for the user, wherein the content consumption history for the user includes information regarding the one or more electronic devices, one or more applications on the one or more electronic devices, and/or specific content consumed.

3. The computer-implemented method of claim 2, further comprising:
providing a knowledge corpus based on the content consumption history for the user, wherein the knowledge corpus includes information selected from the group consisting of a timestamp, a length of time, an identification of the one or more electronic devices, an action classification, an identification of a type of content, an identification of a specific item of content, an application, an item of interaction data, and combinations thereof.

4. The computer-implemented method of claim 1, further comprising:
providing a rule for alerting the user, wherein the rule weighs criteria including time spent on a respective electronic device of the one or more electronic devices, time spent on collective electronic devices of the one or more electronic devices, single sessions logged, multiple sessions logged, time spent on respective applications, and combinations thereof.

5. The computer implemented method of claim 1, wherein the negative attention pattern is selected from the group consisting of the user consumed repetitive content, the user non-purposefully consumed content, and the user non-purposefully consumed repetitive content.

6. The computer-implemented method of claim 1, wherein the one or more electronic devices includes a first electronic device and a second electronic device, and wherein evaluating the content consumption by the user for the negative attention pattern includes determining that the user consumed content on the first electronic device and consumed repetitive content on the second electronic device.

7. The computer-implemented method of claim 1, further comprising:
automatically responding to the negative attention pattern with an action selected from the group consisting of requiring an action by the user to continue viewing content, disabling an application, disabling the electronic device, disabling content, and combinations thereof.

8. A computer program product for monitoring content consumption and alerting a user to a negative attention pattern, the computer program product comprising: one or more computer-readable storage media; and program instructions stored on the one or more storage media to perform operations comprising:
detecting an application interaction by the user on one or more electronic devices;
initiating a monitoring time period in response to detecting the application interaction by the user on the one or more electronic devices;
monitoring content consumption by the user on the one or more electronic devices over the monitoring time period, wherein monitoring content consumption by the user includes monitoring content being consumed by the user, monitoring one or more applications used by the user, and/or capturing application interaction data of the user with the one or more applications being used by the user;
evaluating the monitored content consumption by the user over the monitoring time period for the negative attention pattern; and
generating an alert when the negative attention pattern is determined to be present.

9. The computer program product of claim 8, wherein the operations further comprise:
providing a content consumption history for the user, wherein the content consumption history for the user includes information regarding the one or more electronic devices, one or more applications on the one or more electronic devices, and/or specific content consumed.

10. The computer program product of claim 9, wherein the operations further comprise:
providing a knowledge corpus based on the content consumption history for the user, wherein the knowledge corpus includes information selected from the group consisting of a timestamp, a length of time, an identification of the one or more electronic devices, an action classification, an identification of a type of content, an identification of a specific item of content, an application, an item of interaction data, and combinations thereof.

11. The computer program product of claim 8, wherein the operations further comprise:
providing a rule for alerting the user, wherein the rule weighs criteria including time spent on a respective electronic device of the one or more electronic devices, time spent on collective electronic devices of the one or more electronic devices, single sessions logged, multiple sessions logged, time spent on respective applications, and combinations thereof.

12. The computer program product of claim 8, wherein the negative attention pattern is selected from the group consisting of the user consumed repetitive content, the user non-purposefully consumed content, and the user non-purposefully consumed repetitive content.

13. The computer program product of claim 8, wherein the one or more electronic devices includes a first electronic device and a second electronic device, and wherein evaluating the content consumption by the user for the negative attention pattern includes determining that the user consumed content on the first electronic device and consumed repetitive content on the second electronic device.

14. The computer program product of claim 8, wherein the operations further comprise: automatically responding to the negative attention pattern with an action selected from the group consisting of requiring an action by the user to continue viewing content, disabling an application, disabling the electronic device, disabling content, and combinations thereof.

15. A computer system, comprising:
a processor set;
one or more computer-readable storage media; and
program instructions stored on the one or more storage media to cause the processor set to perform operations comprising:
detecting an application interaction by the user on one or more electronic devices;
initiating a monitoring time period in response to detecting the application interaction by the user on the one or more electronic devices;
monitoring content consumption by the user on the one or more electronic devices over the monitoring time period, wherein monitoring content consumption by the user includes monitoring content being consumed by the user, monitoring one or more applications used by the user, and/or capturing application interaction data of the user with the one or more applications being used by the user;
evaluating the monitored content consumption by the user over the monitoring time period for a negative attention pattern; and
generating an alert when the negative attention pattern is determined to be present.

16. The computer system of claim 15, wherein the operations further comprise:
providing a content consumption history for the user, wherein the content consumption history for the user includes information regarding the one or more electronic devices, one or more applications on the one or more electronic devices, and/or specific content consumed.

17. The computer system of claim 16, wherein the operations further comprise:
providing a knowledge corpus based on the content consumption history for the user, wherein the knowledge corpus includes information selected from the group consisting of a timestamp, a length of time, an identification of the one or more electronic devices, an action classification, an identification of a type of content, an identification of a specific item of content, an application, an item of interaction data, and combinations thereof.

18. The computer system of claim 15, wherein the operations further comprise:
providing a rule for alerting the user, wherein the rule weighs criteria including time spent on a respective electronic device of the one or more electronic devices, time spent on collective electronic devices of the one or more electronic devices, single sessions logged, multiple sessions logged, time spent on respective applications, and combinations thereof.

19. The computer system of claim 15, wherein the negative attention pattern is selected from the group consisting of the user consumed repetitive content, the user non-purposefully consumed content, and the user non-purposefully consumed repetitive content.

20. The computer system of claim 15, wherein the one or more electronic devices includes a first electronic device and a second electronic device, and wherein evaluating the content consumption by the user for the negative attention pattern includes determining that the user consumed content on the first electronic device and consumed repetitive content on the second electronic device.
